(19) United States
(12) Patent Application Publication
(10) Pub. No.: US 2013/0160352 A1
(43) Pub. Date: Jun. 27, 2013

(54) Collapsible Crustacean Trap

(71) Applicant: Jeffrey Richard HAYES, Coombabah (AU)

(72) Inventor: Jeffrey Richard HAYES, Coombabah (AU)

(21) Appl. No.: 13/735,057

(22) Filed: Jan. 7, 2013

Related U.S. Application Data
(63) Continuation-in-part of application No. PCT/AU2011/000849, filed on Jul. 6, 2011.

(30) Foreign Application Priority Data
Jul. 6, 2010 (AU) 2010902984

(51) Int. Cl. A01K 69/10

(52) U.S. Cl. CPC A01K 69/10
USPC 43/105

(57) ABSTRACT

A crustacean trap includes a bottom wall and a side wall that extends from the bottom wall, the side wall being collapsible so that an operatively upper end of the side wall is displaceable towards and away from the bottom wall. An entryway is provided towards the upper end of the crustacean trap to allow a crustacean to enter the crustacean trap. Afloat is towards the upper end of the side wall and a sinker is towards a lower end of the side wall. A buoyancy of the float and a weight of the sinker have a relationship such that when the crustacean trap is placed in water the crustacean trap sinks and the float displaces the upper end of the side wall away from the bottom wall.

### CROSS-REFERENCES TO RELATED APPLICATIONS

This is a continuation-in-part of international application PCT/AU2011/000849, filed Jul. 6, 2011, which designated the United States. International application PCT/AU2011/000849 itself claimed priority to Australian application 2010902984, filed Jul. 6, 2010. Applicant hereby claims the right of priority and the benefit of these earlier-filed applications under 35 U.S.C. §120, 365(c), and/or other applicable statutes.

### FIELD OF THE INVENTION

This invention relates to a crustacean trap.

### BACKGROUND TO THE INVENTION

Crustacean traps, also referred to as crab pots or dillies, are used to capture crustaceans by luring them into the crustacean trap with some type of bait.

### SUMMARY OF THE INVENTION

The invention provides a crustacean trap, which includes:
a bottom wall and a side wall that extends from the bottom wall, the side wall being capable of collapsing and expanding so that an operatively upper end of the side wall is displaceable towards and away from the bottom wall, respectively, the bottom and side walls partially enclosing a volume when the side wall expands and defining an entryway towards the upper end of the side wall to allow a crustacean to enter the volume when the side wall is expanded;
a float towards the upper end of the side wall; and
a sinker towards a lower end of the side wall;
in which a buoyancy of the float and a weight of the sinker have a relationship such that when the crustacean trap is placed in water the crustacean trap sinks and the float displaces the upper end of the side wall away from the bottom wall to expand the side wall and render operative the trap.

The crustacean trap may include:
a bottom rim and netting spanning the bottom rim to form the bottom wall,
an upper rim; and
netting extending between the bottom rim and the upper rim to form the side wall.

The bottom rim may form the sinker and the top rim member may form the float.

The upper rim and the bottom rim may be circular in shape, and the upper rim may have a radius of curvature that is smaller than that of the bottom rim, so that the crustacean trap is generally frusto-conical in shape when the upper end of the side wall is displaced away from the bottom wall.

It is to be appreciated that the bottom and upper rims can be of any number of shapes. More particularly, but not exclusively, the bottom and upper rims can be of any number of closed shapes.

The crustacean trap may include an upper wall that defines the entryway.

The crustacean trap may include an open ended tube that is mounted in the upper wall to define the entryway.

The crustacean trap may include a trap door that covers the entryway, the trap door permitting entry of a crustacean into the crustacean trap and inhibiting exiting of a crustacean from the crustacean trap.

The trap door may include an open ended tube fitted within the top wall and a spring loaded door that extends across the open ended tube and that is configured to permit entry of a crustacean into the crustacean trap and inhibits exiting of a crustacean from the crustacean trap.

The trap door may include a hinge towards an edge of the spring loaded door. In another embodiment, the trap door may include a hinge extending centrally across the trap door.

The crustacean trap may include at least one support member that is attached, in a releasable manner, between the bottom member and the top member to support the top rim member spaced from the bottom rim member.

One end of the support member may be attachable, in a releasable manner, to one of the rim members and another end of the support member may be attached, in a pivotal manner, to the other one of the rim members.

The crustacean trap may include an access opening and associated closure in any one of the side wall and bottom wall to enable removal of a crustacean from the crustacean trap. The closure may include a zipper extending substantially across the bottom wall.

The crustacean trap may include an outer member located on the outside of the bottom rim to provide a protective barrier for the bottom rim.

According to another aspect of the invention there is provided a collapsible crustacean trap including:
a bottom wall, a top wall, and a flexible side wall substantially enclosing a crustacean trap interior;
an entryway in the top wall, said entryway allowing crustaceans to enter the trap and further including a means to prevent crustaceans from leaving the trap;
a top rim and a bottom rim;
a net attached to the top rim and the bottom rim, the net forming the flexible side wall of the trap; and
at least one side support member attached, in a releasable manner, to one of the rims for holding the trap in an open position.

The means to inhibit crustaceans from leaving the trap may include an open ended tube fitted within the top wall. The tube may be attached to the net and may include a distance between its upper and lower edges that discourages or inhibits a crustacean from gripping on to the upper edge in an attempt to exit the crustacean trap.

The means to inhibit crustaceans leaving the trap may include a spring loaded trap door attached to the tube. The means to inhibit crustaceans leaving the trap may include a trap door extending across the tube. The door may be pivotal about a central transverse axis of the tube so as to form a swing door.

The at least one side support member may be elongated. One end of the side support member may be hinged or pivotally attached to the bottom rim member and another end of the side support member may be attachable, in a releasable manner, to the top rim member, such that when the crustacean trap is erected for use the top member is braced by the side support member away from the bottom member. The side support member may be located at an inside of the side wall. The side support member may be formed from a synthetic or natural organic material. The crustacean trap may include a plurality of side support members spaced apart along an outer periphery of the crustacean trap.

The crustacean trap may include a closure in one of its walls to facilitate the removal of crustaceans from the crustacean trap. The closure may include zipper in the bottom wall of the crustacean trap.

In other embodiments, the top rim and the bottom rim may be shaped to form a square, rectangle, circle, or the like. In such embodiments, the top rim may have a width or diameter which is less than a width or diameter of the bottom rim.

The crustacean trap may include an outer bottom member that is located on an outside of the bottom rim to provide or define a buffer or barrier for the bottom rim. The crustacean trap may include an adjustment member that is able to compress or expand the bottom member towards and away from the bottom rim to allow access to the portion of the net cooperating with the bottom rim.

The top rim may be formed from a buoyant material, which when placed in the water floats above the bottom rim to hold the crustacean trap in an open position.

The invention also provides a collapsible crustacean trap including:
a bottom wall, a top wall, and a side wall substantially enclosing a crustacean trap interior;
an entryway in the top wall, said entryway allowing crustaceans to enter the trap and including a means to prevent crustaceans from leaving the trap;
a top member and a bottom member; and
a net attached to the bottom member and the top member, the net defining flexible sides of the trap; wherein the top member is buoyant so that when the trap is placed in water the top member floats above the bottom member to hold the crustacean trap in an open position.

The collapsible crustacean trap may include any one of the features of the collapsible crustacean trap as herein defined, described, and illustrated.

### BRIEF DESCRIPTION OF THE DRAWINGS

A crustacean trap, in accordance with the invention, may manifest itself in a variety of forms. It will be convenient hereinafter to describe embodiments of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description.

FIG. 1 shows a three-dimensional view of the crustacean trap, in accordance with the invention;

FIG. 2 shows a perspective view of the crustacean trap in FIG. 1, when collapsed;

FIG. 3 shows a three-dimensional view of the crustacean trap in FIG. 1 from beneath the trap;

FIG. 4 shows a side elevation view of another embedment of a crustacean trap, in accordance with the invention;

FIG. 5 shows a side elevation view of another embodiment of the crustacean trap, in accordance with the invention;

FIG. 6 shows a partly sectioned side elevation view of another crustacean trap, in accordance with the invention;

FIG. 7 shows a three-dimensional view of another embodiment of a crustacean trap, in accordance with the invention;

FIG. 7A shows a detailed, partly exploded view of part of the crustacean trap in FIG. 7;

FIG. 8 shows a three-dimensional view of another embodiment of crustacean trap, in accordance with the invention, when collapsed;

FIG. 9 shows a top plan view of the crustacean trap in FIG. 8; and

FIG. 10 shows a three-dimensional view of the crustacean trap in FIG. 8, in use.

### DETAILED DESCRIPTION OF THE PREFERRED EMBODIMENTS

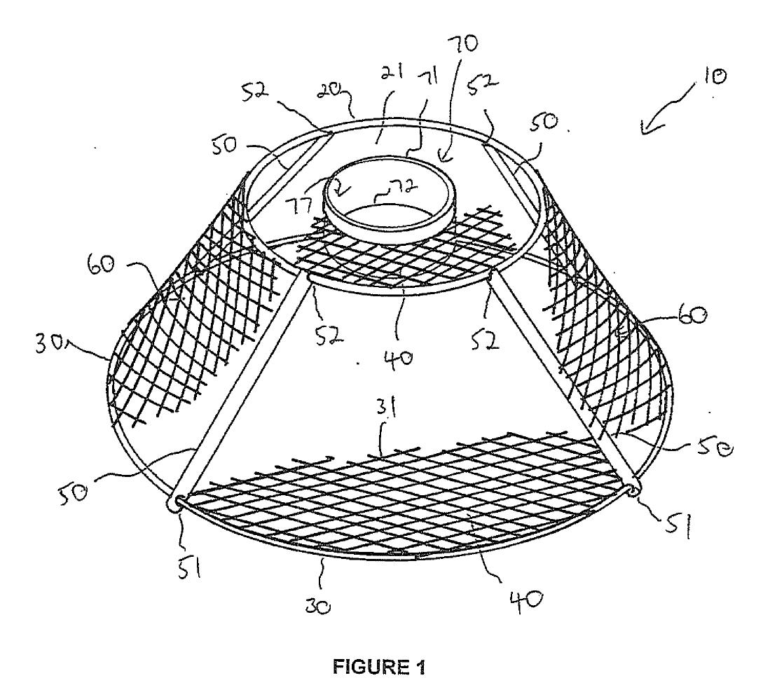

In FIGS. 1 to 3, reference numeral 10 indicates a crustacean trap 10, in accordance with the invention. The crustacean trap 10 includes an upper wall 21, a bottom wall 31, and side wall 60. The crustacean trap includes an operatively upper rim 20 and a lower rim 30, and netting 40 that extends across the lower rim 30, between the rim 20, 30, and at least partly across the upper rim 40 to form the walls 21, 31, and 60. The crustacean trap 10 further includes a plurality of collapsible support members 50 disposed around the outer periphery of the trap 10, as is explained in more detail below. In some of the drawings, the netting 49 is partly illustrated only, so as to reveal other detail in the drawings for clarity of illustration.

The crustacean trap 10 is particularly suited for trapping lobsters, shrimps, crabs, barnacles, and crayfish.

In this embodiment, each rim 20, 30 is in the form of a ring. However, rims for other embodiments of a crustacean trap in accordance with the invention may be configured to be generally elliptical, rectangular, square, or the like.

As depicted in FIGS. 1 to 3, the overall shape of the trap 10 is generally frusto-conical. However, in other embodiments the crustacean trap can be generally cubical, cylindrical, triangular prism, or the like. It will be appreciated that for practical purposes it is not possible to illustrate all the different possible shapes in the drawings. The truncated cone or frusto-conical shape may also lend itself to other truncated shapes such as a truncated triangular prism.

The various parts of the trap 10 may be formed from any associated suitable materials, including metals such as aluminium, steel, or various metal alloys; and plastic materials including polyvinylchloride (PVC) and other sturdy composite materials. The net 40 is formed from a flexible material such as plastic strands, or a collapsible wire strand mesh. The wire strands can formed from vinyl coated wire strands.

In this embodiment, four support members 50 are used which are generally elongated and releasably attachable to one of said members 20, 30 and attached to the other member 20, 30. The support members 50 are spaced apart around the outer periphery of the crustacean trap at equal distances from each other. In the case where a crustacean trap is shaped as a cube or rectangle, support members can be positioned at corners. The number of support members to be used can depend on the size and shape of the trap 10.

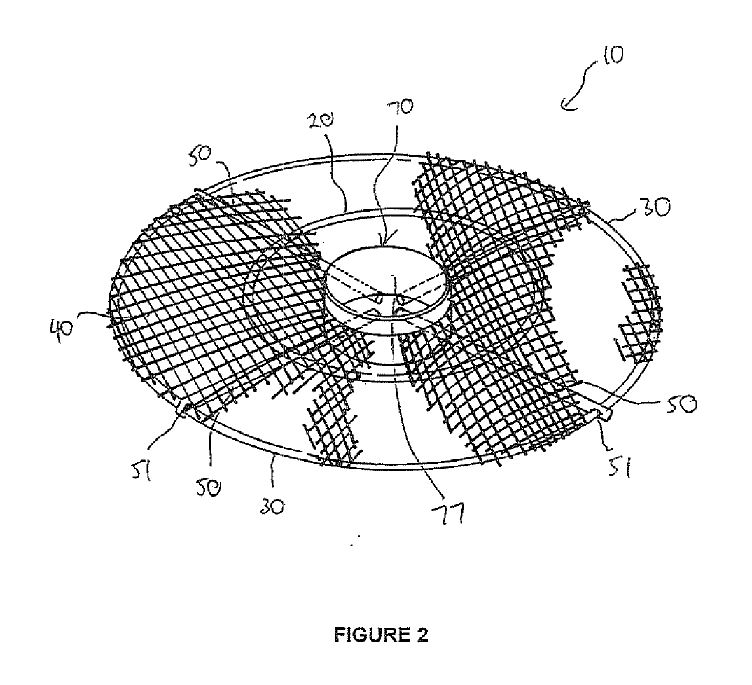

As can be seen in FIG. 2, when the support means 50 are released from the top member 20, then the trap 10 collapses with its top wall and bottom wall moving towards each other.

The support members 50 each include a ring formation toward one end through which the bottom rim 30 passes. The support members 50 are attached to the bottom rim 30. Various mechanical connections can be used, such as a hook and eye formation or the like which allows the support member 50 to be attached yet movable or pivotal relative to the bottom rim 30. The top end 52 of each support member 50 has a V-shaped cut-out or similar formation to cooperate with the top rim 20 to hold the top rim 20 spaced away from the bottom rim 30, in use.

The frusto-conical shaped crustacean trap 10 has side walls 60 that slope, and therefore facilitates crawling of crustaceans up the side wall, as opposed to conventional traps having side walls that are upright and that may discourage a crustacean from approaching the bait.

The crustacean trap 10 includes a tube 77 having a top edge 71 and a spaced apart lower edge 72. The distance between the top edge 71 and the bottom edge 72 of the tube 77 is such that once the crustacean enters the trap 10, the top edge is out of reach of the crustacean to inhibit or prevent the crustacean from exiting the trap 10.

The tube 77 and the netting 40 at the top wall 21 can be cast integrally to attach the tube 77 to the netting 40. This also resists fraying of the netting 40 where it meets the tube 77.

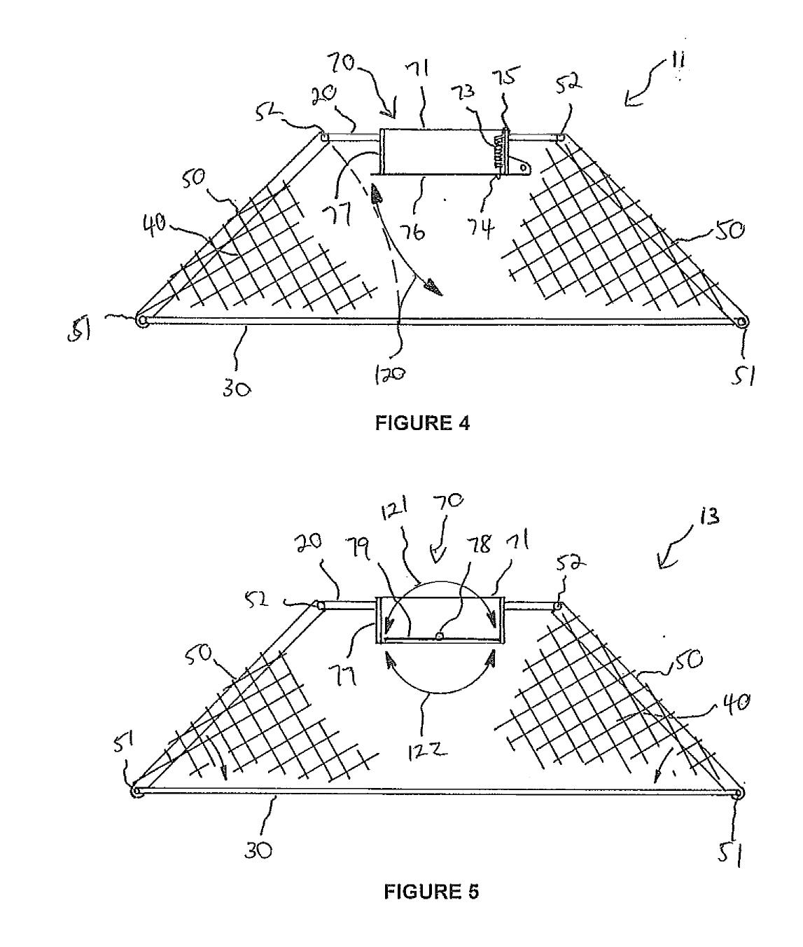

FIGS. 4 and 5 show embodiments of crustacean traps 11 and 13 that include trap doors 76, 79 attached to a tube 77. FIG. 4 shows a door 76 attached at a bottom end 72 of the tube 77 with a spring 73. The spring 73 is attached near a top end of the tube 77, at 75, and the other end of the spring 73 to the door 76, at 74. When a crustacean crawls into the entryway 70 and onto the door 76, the weight of the crab can overcome the spring tension of the spring 73 so that the trap door 76 opens in the direction of the arrow 120 dropping the crab into the trap 11 and automatically returning to its resting position, see arrow 120, to close the entryway.

FIG. 5 shows another embodiment of a trap door 79 which is in the form of a swinging door that is pivotal about a pivot 78 which is located substantially in the middle of the door 79 and is also aligned with the middle of the tube 77. The pivot 78 allows the door 79 to pivot about the pivot axis defined across the diameter of the tube 77. When a crab crawls into the entryway 70 and down onto the door 79, the door pivots and drops the crab into the trap 13. The trap door 79 can be biased to facilitate it returning to its closed position.

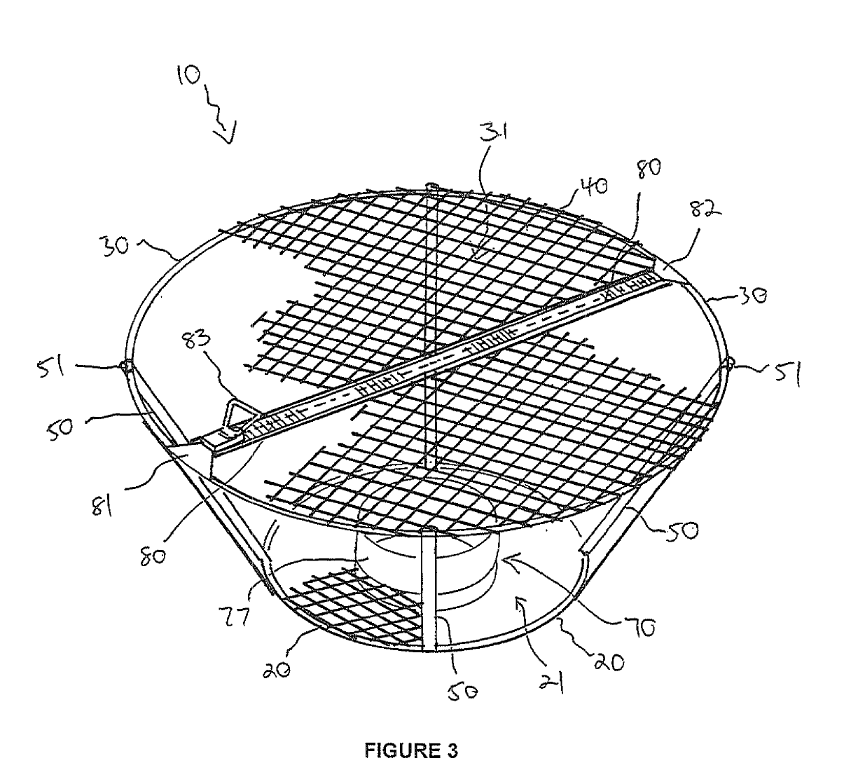

Referring to FIG. 3, the bottom wall 31 includes an access opening and a closure in the form of a zipper 80 for closing the access opening. The zipper 80 extends across the bottom wall 31 and is joined at either end 81, 82 to the bottom rim member 30. The zipper 80 can be opened to permit removal of the trapped crustaceans. For example, the trap 10 can be turned upside down, the zipper 80 opened, and then by simply shaking the trap 10, the crustaceans will fall from the trap 10 into a container.

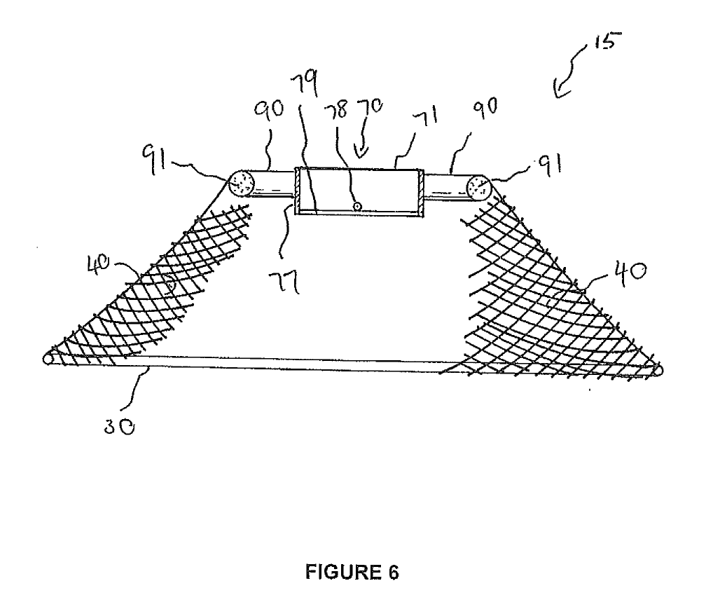

In a further embodiment shown in FIG. 6, a crustacean trap 15 includes a top rim that is formed by a material so as to form a float or buoyant rim 90, and a bottom rim that is formed from a material so as to form a sinker or ballast. The buoyancy of the float 90 and the weight of the sinker 30 are such that when the crustacean trap 15 is placed in water the float 90 floats above the bottom rim 30 to hold the crustacean trap 15 in an open position. In such a case, the support members 50 may not be needed. The float 90 can be formed from a ring of PVC or other plastic material that is filled with expanded foam 91. The expanded foam 91 is any expanding foam, which cures into a semi rigid closed cell foam to provide a lightweight flotation foam which provides buoyancy. The type of foams used are considered closed-cell, which means that each cell that makes up the foam structure is closed off from surrounding cells which prevents the foam from soaking up water or acting like a sponge.

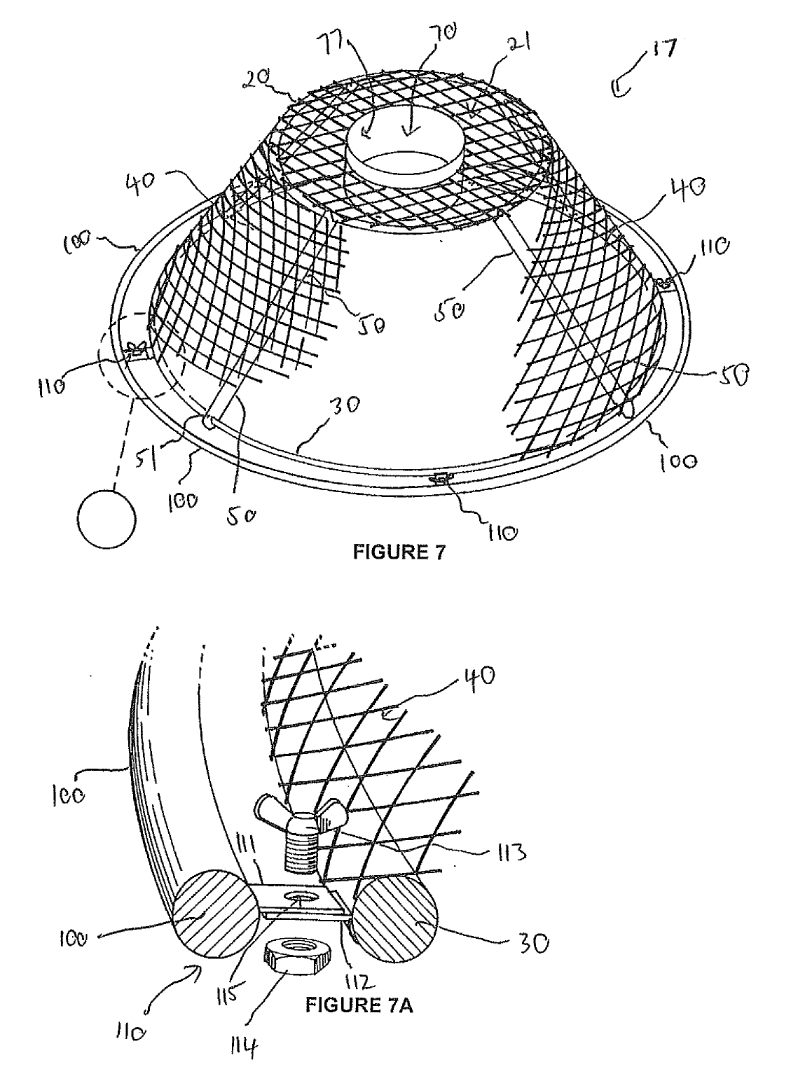

In a further embodiment, the trap 17 (see FIGS. 7 and 7A) includes an outer member 100 located on the outside of the net 40 and spaced apart from the bottom rim 30. The outer member 100 is of similar shape to the bottom rim 30. But it has a larger diameter so that the outer member 100 is locatable on the outside of the bottom rim 30 and spaced apart from the bottom rim 30. The outer member 100 protects the net 40 that is attached to the bottom rim 30 when the trap is lowered and raised from the water and into the boat (not shown). The outer member 100 also protects the netting from becoming damaged or frayed when it contacts the side or hull of the boat. The outer member 100 acts as a buffer between the trap 17 and the boat.

The outer member 100 is attached to the bottom rim 30 by an adjustment member 110 which connects the outer member 100 to the bottom rim 30.

The outer member 100 is used to compress or expand the bottom member 30 to aid in the removal and repair to the net 40. The adjustment member 110 is used to compress or expand the bottom rim 30 to allow the net to be removed to perform maintenance. In order to compress the bottom rim 30 the adjustment member 110 includes a tab 111 suitably attached to the outer member 100 and a corresponding tab 112 suitably attached to the bottom rim 30. These tabs 111, 112 may be welded or attached to the outer member and bottom rim 100, 30, by any other known method which will allow the secure attachment of the tabs 111, 112.

One of the tabs 111, 112 defines an aperture or hole (which can be drilled) 115. A slotted aperture (not shown) is positioned or defined in the other tab 111, 112 above or below the aperture 115. A wing screw 113 which is a threaded screw with winglike projections for thumb and forefinger leverage in turning is positioned through the aperture 115 and the slotted aperture and is secured with a nut 114 that is placed on the end of the wing screw 113.

In order to compress or expand the bottom rim 30 to remove or repair the net 40 the slotted aperture in one of the tabs 111, 112 is pressed inwards by a user and with the bottom rim 30 compressed the wing screw 113 is tightened using the nut 114 and the bottom rim 30 is held in a compressed position such that the net 40 may be removed from the bottom rim 30 for maintenance. Other methods of compressing or expanding the bottom rim 30 may be used without departing from the present invention, likewise other forms of the attachment means 110 may also be substituted without departing from the present invention.

A method of constructing a collapsible crustacean trap will now be described.

The steps for constructing a trap include:
cutting a net 40 to a desired shape;
forming a bottom rim 30 and a top rim 20 to a desired shape;
attaching fixedly at least one support member 50 to one of the bottom rim 30 or the top rim 20 and releasably attaching the at least one support member 50 to the other of the rims 20, 30;
forming an entryway 70 inside of the top member 20 to allow crustaceans to enter the trap 10 and further providing a means 76, 77, 79 to prevent crustaceans from leaving the trap 10; and
enclosing the crustacean trap with the net 40 and attaching the net 40 to the top rim 20, the bottom rim 30 and the entryway 70.

As described above, a number of different embodiments may be used for the trap 10, for example, the top rim 20 may be replaced with the annular buoyant member 90 so that there is no need for the support members 50. Likewise, different means 76, 77, 79 for preventing the crabs from leaving the trap 10 may be used.

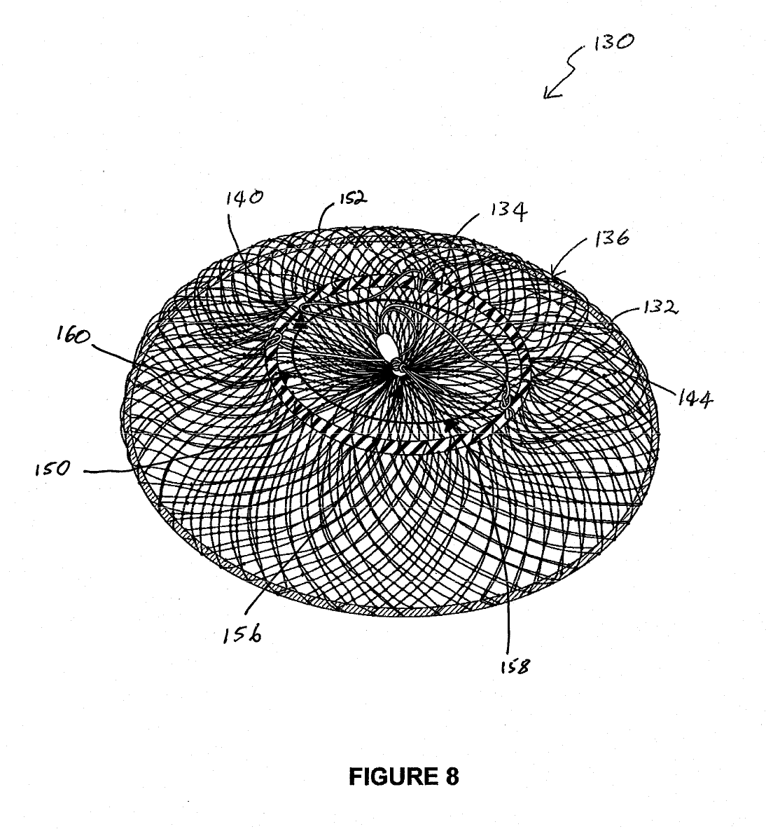

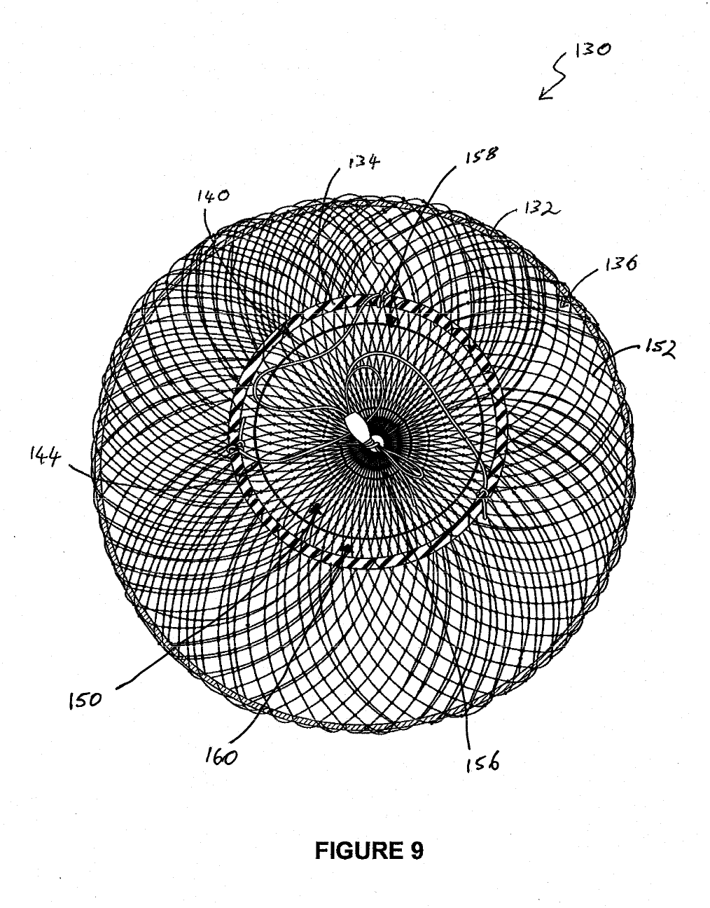

FIGS. 8 to 10 show another embodiment of a crustacean trap 130. The crustacean trap 130 includes an upper rim 134 that forms a float, and a bottom rim 132 that forms a sinker or ballast. A net 136 spans the bottom rim member 132 to define a bottom wall 150 and extends between the bottom rim member 132 and the upper rim member 134 to form a side wall 152.

It will be appreciated that, under gravity, the upper rim or float 134 can collapse towards the bottom rim or sinker 132, generally flattening the trap 130, which is useful for storage. The float 134 and the sinker 132 are configured so that, in water, the trap 134 can sink to a bed while the float 134 serves to expand the side wall 152 to set the trap 130 with the bottom wall 150 and the side wall 152 partially enclosing a volume 154.

The float 134 is in the form of a closed shape and the net 136 is secured to the float 134. The float 134 can be similar in construction to the float 90 as explained above. Instead, the float 134 can be in the form of a hollow tube of plastics material sealed against the ingress of water.

The net 136 can be woven to define a central gathering point 156 and a circular periphery 158]. The float 134 is woven through the net 136 radially inwardly from the periphery 158. A tensioning cord 144 is woven through the net about the periphery to provide a required level of tension within the net 136 when the trap 130 is operative. It follows that the periphery defines an opening or entryway into the volume 154.

As can be seen from FIGS. 8 to 10, a portion of the net 136 between the cord 144 and the float 134 defines a ledge 160 that overhangs the volume 154, enhancing entrapment of crustaceans in the volume 154.

The relationship between the buoyancy of the float 134 and the weight of the sinker 132 is such that when the trap 130 is placed in water the trap 130 sinks and the float 134 pulls away from the sinker 132 to open the trap 130. When a crustacean, such as crab, crawls on to the side wall, the side wall is at least partly depressed to facilitate the crab's approach to the bait inside the trap 130. As soon as the crab moves off the side wall and into the entryway or opening, the float returns to its floating position so that the crab is trapped inside the volume.

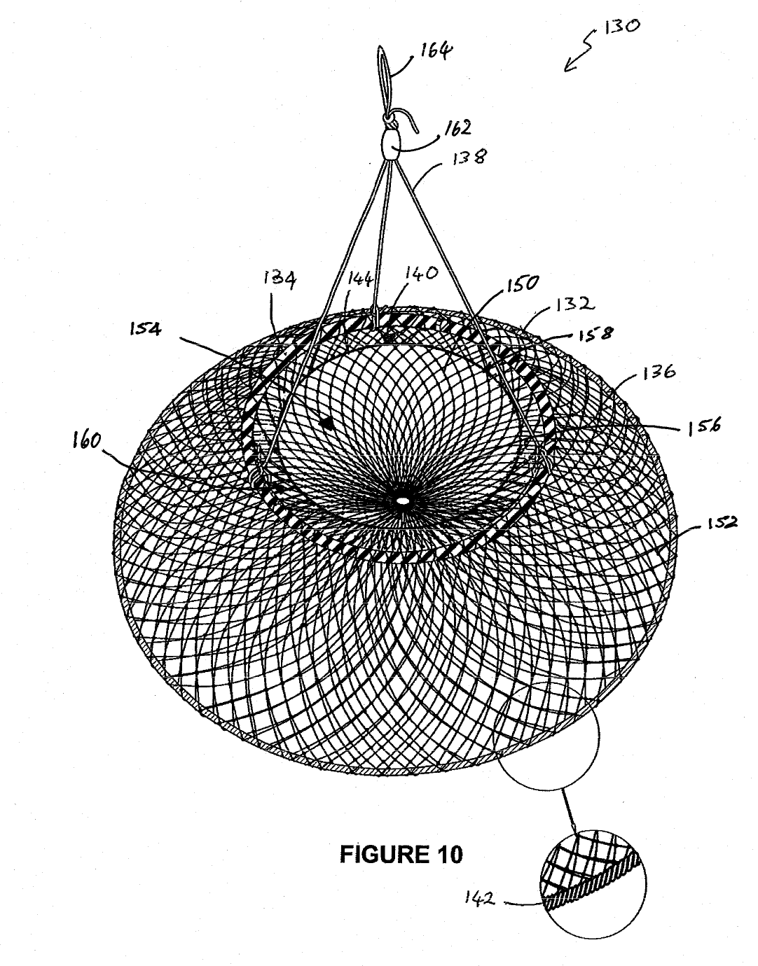

Referring to FIG. 10, there is shown a blown up portion of the bottom rim 132 which includes a flexible cord or rope 142 that is wound around the bottom rim 132 to conceal and protect that part of the net that abuts the bottom rim 132.

The trap 130 includes a number of hanger cords or ropes 138 connected to the float 134 at one end. The cords 138 are threaded through a flotation member or bead 162 and tied together to form a loop 164. Thus, in the water, the cords 138 remain in the position shown in FIG. 10, facilitating retrieval of the trap 130 with a suitable hooking tool or implement. Instead, a rope and buoy arrangement can be attached to the loop to facilitate location and retrieval of the trap 130.

In use, suitable bait is placed inside the trap. The trap is attached to a rope at one end. The other end of the rope is attached to a buoy to mark the location of the trap in the water. The support members 50 are positioned so that they extend between the top rim and the bottom rim to hold the trap in its open position. The trap is then placed inside the water. After some time, the trap is pulled with the rope to the surface and the zipper can be used to facilitate removal of the crustaceans from the trap.

The present invention provides a number of uses or applications, such as the collapsible nature of the trap which allows a fisherman to carry an increased number of traps due to the fact that the collapsible trap allows more room on the boat to store the traps. This allows the fisherman to increase a catch size due to the increased number of traps in the water without necessarily increasing required storage of unused or inoperative traps.

The entryway of the various embodiments facilitates retention of crabs in the trap.

The netting is selected to have characteristics such as openings in the netting to reduce the chance of any other animals other than crustaceans being caught in the trap.

In those embodiments in which the trap has a conical shape the flow of water is directed out through the entryway while the trap settles, facilitating the landing of the trap in the correct position on a bed such as the ocean floor regardless of how it is thrown into the water.

It should also be noted that the embodiments described herein are not only suitable for use by recreational fishermen but also suitable for use, commercially, such as on commercial fishing boats.

### Definitions

“Including” or “comprising” shall be understood to have a broad meaning and will be understood to imply the inclusion of a stated integer or step or group of integers or steps but not the exclusion of any other integer or step or group of integers or steps. This definition also applies to variations on the term “including” such as “include” and “includes”.

“Crustacean” is meant to include crabs, lobsters, and crayfish.

“Towards” when used with reference to a position of a component is meant to include a terminal location, for example, “towards an upper end” is meant to include the “upper end”.

Words such as “upper”, “lower”, “bottom”, “side” and “top” have only been used for convenience and with reference to an operative condition of the embodiments described herein.

Although the present invention has been illustrated and described with respect to exemplary embodiment thereof, it should be understood by those skilled in the art that the foregoing and various other changes, omissions and additions may be made therein and thereto, without departing from the scope of the present invention. Therefore, the present invention should not be understood as limited to the specific embodiment set out above but to include all possible embodiments which can be embodied within a scope encompassed and equivalent thereof with respect to the feature set out in the appended claims.

1. A crustacean trap, which includes:
a bottom wall and a side wall that extends from the bottom wall, the side wall being collapsible so that an operatively upper end of the side wall is displaceable towards and away from the bottom wall, an entryway being provided towards the upper end of the crustacean trap to allow a crustacean to enter the crustacean trap;
a float towards the upper end of the side wall; and
a sinker towards a lower end of the side wall;
in which a buoyancy of the float and a weight of the sinker have a relationship such that when the crustacean trap is placed in water the crustacean trap sinks and the float displaces the upper end of the side wall away from the bottom wall.

2. A crustacean trap as claimed in claim 1, which includes:
a bottom rim and netting spanning the bottom rim to form the bottom wall,
an upper rim, and
netting extending between the bottom rim and the upper rim to form the side wall.

3. A crustacean trap as claimed in claim 2, in which the sinker is defined at least in part by the bottom rim and the top rim forms the float.

4. A crustacean trap as claimed in claim 3, in which the upper rim and the bottom rim are circular in shape, and in which the upper rim has a radius of curvature that is smaller than that of the bottom rim, so that the crustacean trap is generally frusto-conical in shape when the upper end of the side wall is displaced away from the bottom wall.

5. A crustacean trap as claimed in claim 4, which includes an upper wall that defines the entryway.

6. A crustacean trap as claimed in clam 5, in which an open ended tube is mounted in the upper wall to define the entryway.

7. A crustacean trap as claimed in claim 6, which includes a trap door that covers the entryway, the trap door permitting entry of a crustacean into the crustacean trap and inhibiting exiting of a crustacean from the crustacean trap.

8. A crustacean trap as claimed in claim 7, in which the trap door includes an open ended tube fitted within the top wall and a spring loaded door that extends across the open ended tube and that is configured to permit entry of a crustacean into the crustacean trap and to inhibit exiting of a crustacean from the crustacean trap.

9. A crustacean trap as claimed in claim 8, in which the trap door includes a hinge towards an edge of the spring loaded door.

10. A crustacean trap as claimed in claim 9, in which the trap door includes a hinge extending centrally across the trap door.

11. A crustacean trap as claimed in claim 10, which includes at least one support member that is attached, in a releasable manner, between the bottom rim and the top rim to support the top rim spaced from the bottom rim.

12. A crustacean trap as claimed in claim 11, in which one end of the support member is attached, in releasable manner, to one of the rims and another end of the support member is attached, in a pivotal manner, to the other of the rims.

13. A crustacean trap as claimed in claim 12, which includes an access opening and an associated closure in any one of the side wall and bottom wall to enable removal of a crustacean from the crustacean trap.

14. A crustacean trap as claimed in claim 13, in which the closure includes a zipper extending substantially across the bottom wall.

15. A crustacean trap as claimed in claim 14, which includes an outer member located on the outside of the bottom rim to provide a protective barrier for the bottom rim member.
